(19) United States
(12) Patent Application Publication
(10) Pub. No.: US 2005/0041198 A1
(43) Pub. Date: Feb. 24, 2005

(54) Glasses

(76) Inventors: Klaus Rapp, Icking (DE); Emil Viktorin, Wasserburg (DE); Heinz Pellert, Muenchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/478,491

(22) PCT Filed: May 16, 2002
(86) PCT No.: PCT/DE02/01763

(30) Foreign Application Priority Data
May 22, 2001 (DE) 101 25 231.5

(51) Int. Cl. G02C 1/00

(52) U.S. Cl. 351/41

(57) ABSTRACT

What is described is a pair of eyeglasses with a bridge that connects the two glass lenses and with flat holders mounted on the lenses to support the side pieces, wherein the lenses are connected to the holders and to the bridge by means of a fixation device (1).

The invention is characterized by the fact that at least one fixation device (1) comprises a loop (2) that is inserted into an opening in the glass lens, the length of the loop being adaptable to various thicknesses of the glass.

### TECHNICAL AREA

The invention relates to a pair of eyeglasses with a bridge that connects the two lenses and with flat holders attached to the lenses to support the side pieces (i.e., the arms or bows) of the frame, wherein the lenses are connected to the holders and to the bridge by means of a fixation device.

### STATE OF THE ART

The lenses of eyeglasses and the various components of the frame in which they are mounted are ordinarily connected to one another by means of screws, screw sleeves or threaded pins and nuts. So that the arrangement will not be twisted out of place, it is usually secured by a fixation means passing through two bores, or by a pin-in-notch device, at the edge of the glass lenses. A commonly employed procedure is to insert a U-shaped wire into slots in the glass.

The European application EP 0 561 763 A1 describes a lens-holding portion of a frame for eyeglasses in which retaining pins supported on a frame part are disposed in pairs and each such pin engages a bore in the glass lens; in this case the retaining pins consist of the extending legs of a piece of wire bent into a U shape, which is attached to the frame part by way of the crosspiece that connects the two legs.

The European application EP 1 024 390 A1 describes a drilled frame that has a bridge connecting the two lenses and also attachments, each of which comprises a rodlike attachment element; in this design, each of the rodlike attachment elements includes a widened region and the lenses comprise correspondingly shaped, slitlike bores spaced apart from the edge of the glass, to expand the potential contact region and thus enable form-fitting engagement that generates no tension and is secure against rotation.

In most of the fixation devices known in the state of the art, an elaborate processing of the glass is required, part of which can be accomplished only with special tools. Furthermore, it is often necessary to handle loose parts, which must be supplied with various forms of fixation devices so as to enable the eyeglasses frame to be fitted with lenses ranging from very thin to very thick.

### DESCRIPTION OF THE INVENTION

It is the objective of the invention to avoid the disadvantages of the state of the art as described above and to make available eyeglasses with a fixation device that demands no special tool for glass processing, permits the dimensions to be extremely small, and nevertheless guarantees secure fixation of the lenses.

This objective is achieved in that at least one fixation device has the shape of a loop and is inserted into an opening in the glass, the length of the loop being adapted to accommodate lenses of various thickness.

The loop can be a wire, a bundle of fine wires or a bundle of fibres.

The opening in the glass comprises either one bore positioned near the edge or two bores of equal diameter.

The length of the loop is either continuously adjustable, or can be adapted stepwise to different thicknesses of glass.

To keep the loops in place, various methods are conceivable. For instance, the loops can be attached by means of a catch mechanism, by adhesive, by welding, by soldering or by a clamped or pinched connection.

If an adhesive is used to keep the loops in position, it can be of several kinds: a radiation-activated adhesive, an adhesive based on epoxy resin, a fusion adhesive or a thermoplastic material.

When the loops are attached by welding, the procedure employed can be of the laser, ultrasound or microresistance type.

The invention will now be described with reference to the figures, wherein

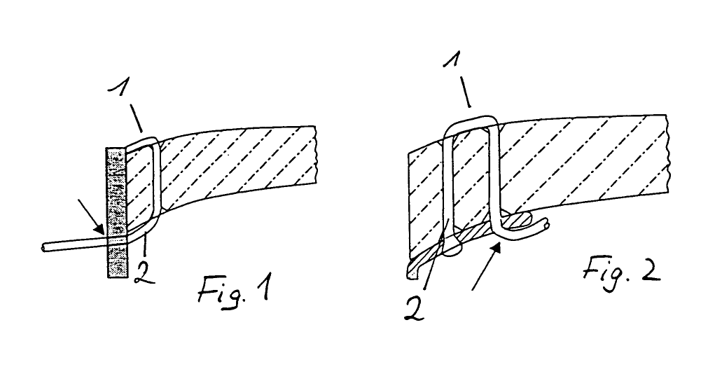

FIG. 1 shows a type of loop fixation with a bore near the outer edge of the lens, and

FIG. 2 shows a type of loop fixation at the back side of the lens, with two bores.

The fixation device (1) consists of a kind of loop (2), which is passed through one bore near the edge of the glass lens (FIG. 1) or else through two closely adjacent bores (FIG. 2) of the same diameter, is then pulled tight and is removably or permanently connected to supporting parts disposed at the edge of the lens, in the first case, or in front of or behind the glass in the second case.

The arrows in the drawings indicate attachment by one of the procedures cited above.

1. Eyeglasses with a bridge that connects the two glass lenses and with flat holders mounted on the lenses to support the side pieces, wherein the lenses are connected to the holders and to the bridge by means of a fixation device, wherein
at least one fixation device comprises a loop that is inserted into an opening in the glass, the length of the loop being adaptable to various thicknesses of the glass.

2. Eyeglasses according to claim 1, wherein the loop is a wire, a bundle of fine wires or a bundle of fibers.

3. Eyeglasses according to claim 1, wherein the opening is a bore positioned near the edge.

4. Eyeglasses according to claim 1, wherein the opening consists of two bores of the same diameter.

5. Eyeglasses according to claim 1, wherein the length of the loop is continuously adjusted to different thicknesses of the glass.

6. Eyeglasses according to claim 1, wherein the length of the loop can be adjusted in a stepwise manner to different thicknesses of the glass.

7. Eyeglasses according to claim 1, wherein the loops are attached by a catch mechanism.

8. Eyeglasses according to claim 1, wherein the loops are attached by adhesive.

9. Eyeglasses according to claim 8, wherein the adhesive is one that can be activated by radiation, or an epoxide-resin-based adhesive, or a fusion adhesive or a synthetic thermoplastic material.

10. Eyeglasses according to claim 1, wherein the loops are attached by welding.

11. Eyeglasses according to claim 10, wherein the welding procedure is a laser, ultrasound or microresistance welding procedure.

12. Eyeglasses according to claim 1, wherein the loops are attached by soft-soldering.

13. Eyeglasses according to claim 1, wherein the loops are attached by a clamped or crimped connection.

14. Eyeglasses according to claim 2, wherein the opening is a bore positioned near the edge.

15. Eyeglasses according to claim 2, wherein the opening consists of two bores of the same diameter.

16. Eyeglasses according to claim 2, wherein the length of the loop is continuously adjusted to different thicknesses of the glass.

17. Eyeglasses according to claim 2, wherein the length of the loop can be adjusted in a stepwise manner to different thicknesses of the glass.

18. Eyeglasses according to claim 2, wherein the loops are attached by a catch mechanism.

19. Eyeglasses according to claim 2, wherein the loops are attached by adhesive.

20. Eyeglasses according to claim 2, wherein the loops are attached by welding.
